(19) United States
(12) Patent Application Publication
(10) Pub. No.: US 2024/0163775 A1
(43) Pub. Date: May 16, 2024

(54) DYNAMIC ASSET TRACKING VIA LOW-ENERGY RADIO FREQUENCY DEVICES

(71) Applicant: Cox Communications, Inc., Atlanta, GA (US)

(72) Inventors: Shadi Renno, Duluth, GA (US); Matthew Brandon Shorts, Alpharetta, GA (US); Peyton Thomas Riley, Cumming, GA (US)

(73) Assignee: Cox Communications, Inc., Atlanta, GA (US)

(21) Appl. No.: 17/987,511

(22) Filed: Nov. 15, 2022

(51) Int. Cl. H04W 48/16

(52) U.S. Cl. CPC H04W 48/16; H04W 52/0209

(57) ABSTRACT

Aspects are described that utilize a distributed network of mobile low-energy (LE) radio frequency (RF) reader devices to detect LE RF beacons relative to a location of each mobile LE RF reader device. According to an aspect, an onboard diagnostics (OBD) device is integrated with or coupled to a mobile LE RF reader device and a wireless backhaul interface. The wireless backhaul interface is configured to provide detection data that includes LE RF beacon data detected by the mobile LE RF reader device to a network server. The network server is configured to receive the detection data including detected LE RF beacon data from a plurality of OBD devices and/or mobile LE RF reader devices. Each mobile LE RF reader device can be configured to detect LE RF beacons and/or output detected LE RF beacon data according to certain trigger events as part of providing power management functionality.

### BACKGROUND

Institute of Electrical and Electronics Engineers (IEEE) 802.15 provides a short-range wireless technology standard that enables formation of wireless personal area networks (PANs). The BLUETOOTH type wireless interfaces enable formation of PANs (BLUETOOTH is a trademark owned by Bluetooth Special Interest Group (SIG)). These types of PANs utilize radio frequency (RF) signals in the 2.402 GHz to 2.48 GHz frequency range. BLUETOOTH low energy (BLE) relies on RF signals to provide PANs but consumes considerably less power. The BLE protocol allows BLE-capable devices to remain asleep or idle in between connections. Once connected, BLE-capable devices only communicate for a few seconds in short bursts with minimal power consumption.

The BLE protocol attempts to provide a technical solution to preserve battery life as wireless devices that are used to form PANs continue to become more complex with increased processing power, data rates, and communication ranges. For example, indiscriminate use of a wireless interface can quickly drain the battery, requiring a user to connect to an A/C power source in order to maintain functionality and recharge the battery which can adversely impact battery life. For example, lithium based batteries have a limited number of charge cycles and frequent battery charging may result in faster battery degradation including adversely affecting a total charge capacity of the batteries. If a battery is not charged in time, the wireless device, or other components relying on battery power, may become inoperative which is an unacceptable outcome in many applications.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Aspects of the present disclosure utilize a distributed network of mobile low-energy (LE) radio frequency (RF) reader devices to detect LE RF beacons relative to a location of each mobile LE RF reader device, but are not so limited. According to an aspect, an onboard diagnostics (OBD) device is integrated with or coupled to a mobile LE RF reader device and a wireless backhaul interface. The wireless backhaul interface is configured to provide detection data that includes LE RF beacon data detected by the mobile LE RF reader device to a network server. The network server is configured to receive the detection data including detected LE RF beacon data from a plurality of OBD devices and/or mobile LE RF reader devices. According to aspects described herein, each mobile LE RF reader device can be configured to detect LE RF beacons and/or output detected LE RF beacon data according to certain trigger events as part of providing power management functionality. Other aspects are described herein.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the present disclosure.

### BRIEF DESCRIPTION OF THE DRAWINGS

Further features, aspects, and advantages of the present disclosure will become better understood by reference to the following figures, wherein like reference numbers indicate like elements throughout the several views:

FIG. 1 is a block diagram of an example communication environment in which aspects of the present disclosure can be implemented;

FIG. 2 is a block diagram of an example wireless backhaul implementation according to an aspect;

FIG. 3 is a communication diagram of an exemplary asset tracking process according to an aspect;

FIG. 4 is a flow diagram of an exemplary method of using low-energy (LE) radio frequency (RF) reader technology to dynamically track assets according to an aspect;

FIG. 5 is a flow diagram of an exemplary method of receiving detection data over a network from a plurality of dynamic LE RF reader devices according to an aspect;

FIG. 6 is a flow diagram of an exemplary method of provisioning LE RF reader devices and LE RF badges and/or LE RF tags according to an aspect; and

FIG. 7 is a block diagram illustrating example physical components of a computing device or system with which embodiments can be practiced.

### DETAILED DESCRIPTION

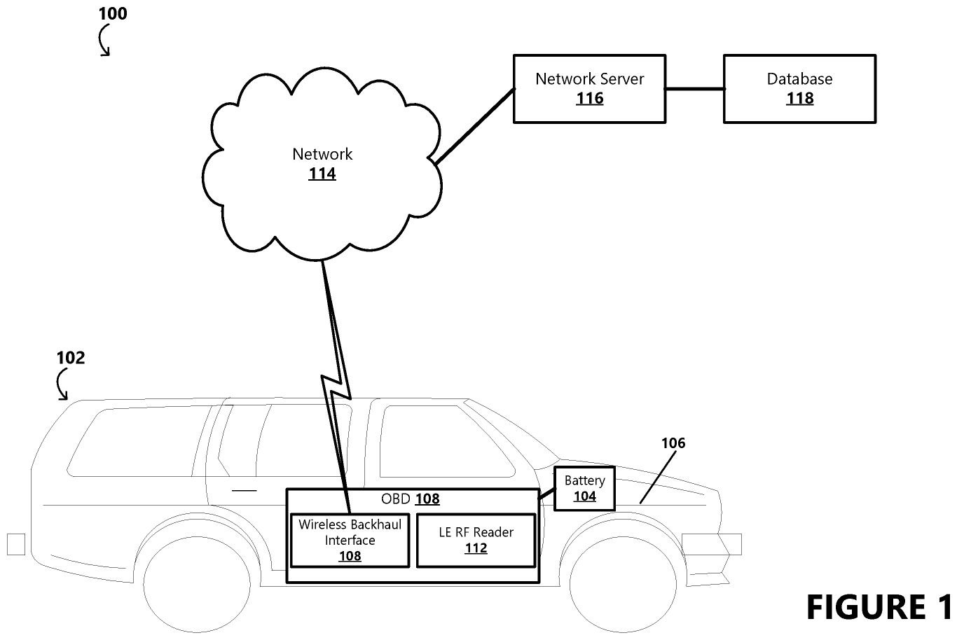

FIG. 1 is a block diagram of an example communication environment 100 in which aspects of the present disclosure can be implemented. As shown in FIG. 1, environment 100 includes at least one vehicle 102 that includes a power source 104, such as a 12 volt battery for example, an engine 106, an onboard diagnostics (OBD) device 108, a wireless backhaul interface 110, and a low-energy (LE) radio frequency (RF) reader device 112 (also referred to as an RF reader or RF reader interface). Components, such as OBD device 108 for example, are not to drawn to scale in FIG. 1, and may be located at different areas of vehicle 102. While vehicles 102, such as automobiles are described in conjunction with the present disclosure, aspects of the disclosure can be practiced in many different types of implementations where integrated or standalone mobile LE RF reader devices 112 are moved from location to location to detect LE RF beacon data at each location, including locations therebetween.

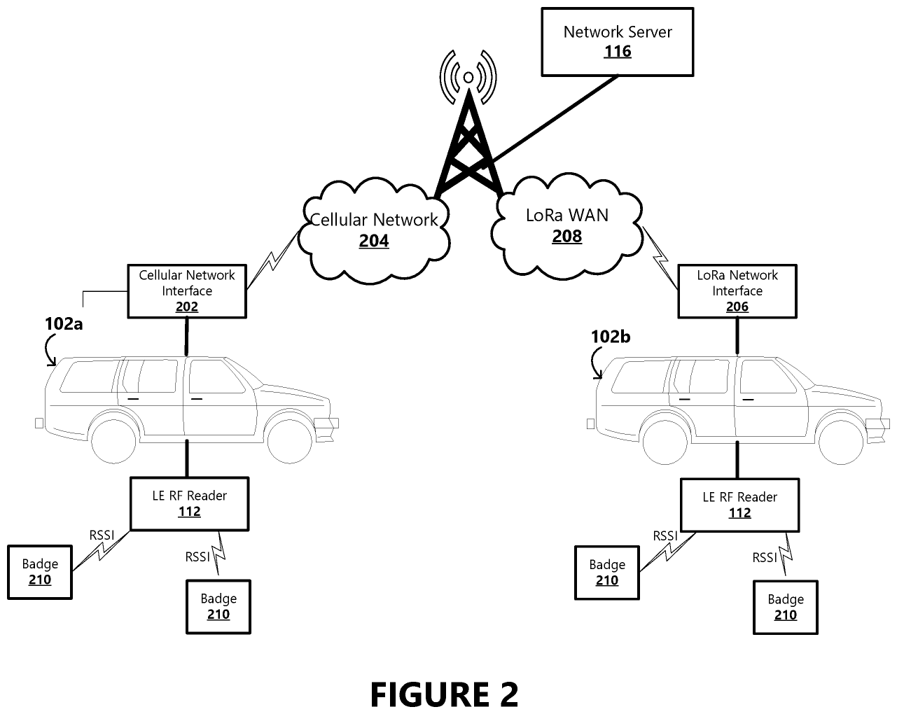

According to an aspect, LE RF reader device 112 and/or wireless backhaul interface 110 can be integrated with OBD device 108 and connected to power source 104. According to one aspect, LE RF reader device 112 can be integrated with wireless backhaul interface 110 as a ruggedized unit with or without an integrated battery and coupled, wired or wirelessly, to OBD device 108. LE RF reader device 112 can be configured to detect BLE beacons and wireless backhaul interface 110 can be configured to communicate sensor data such as detected BLE beacon data, also referred to as detection data, output by LE RF reader device 112 over network 114 to network server 116. As described further below in conjunction with FIG. 2, wireless backhaul interface 110 can be configured to communicate sensor data to network server 116 according to different communication protocols. While one network server 116 is shown in FIG. 1, multiple network servers and/or databases 118 can be deployed according to a desired architectural footprint.

As described below, each mobile LE RF reader device 112 can be configured to detect LE RF beacons and/or output detected LE RF beacon data (e.g., detection data). According to an aspect, mobile LE RF reader device 112 can be configured to begin detecting LE RF beacons according to certain trigger events as part of a power management optimization scheme. For example, an LE RF receiver of LE RF reader device 112 can be powered on to detect LE RF beacons according to various trigger events such as: a bootup process, connection or disconnection to an external voltage source or power source, an ignition event, when engine 106 of vehicle 102 starts, when vehicle 102 moves or stops including continuous motion, when a certain voltage level is detected, when vehicle 102 changes locations, when vehicle 102 is unlocked, a network-based trigger, wherein the network server instructs the RF reader device 112 to scan, etc. As an example, output from an accelerometer or other sensor can be used to trigger the operation of LE RF reader device 112 to power on and begin detecting LE RF beacon signals with its LE RF receiver and antenna. LE RF reader device 112 can also be configured to begin detecting LE RF beacons during a scheduled window or time event according to wake-up programming to perform certain actions at certain times. By judiciously managing when LE RF reader device 112 powers on to detect LE RF beacons and/or provide detected LE RF beacon data, battery life may be prolonged as well as limiting amounts of charging required to recharge batteries powering LE RF reader device 112 and/or OBD device 108.

When integrated with OBD device 108, LE RF reader device 112 can be powered on via battery 104 or with an integrated battery. Likewise, when coupled with vehicle 102 or OBD device 108, a standalone unit that can be configured with a position determining system (e.g., GPS), an LE RF reader device 112, and/or wireless backhaul interface 110 can be powered on via battery 104 or with an integrated battery. According to an aspect, sensor data, including location data, battery charge data, accelerometer data, temperature data, LF RF detection data, etc. can be communicated by wireless backhaul interface 110 over network 114, e.g., a cloud network, to network server 116 at desired times or intervals or upon certain trigger events. For example, when vehicle 102 moves from a first location to a second location, sensor data associated with the first location can be sent to the network server 116 in order to free up onboard memory. Network server 116 can store received sensor data for each LE RF reader device 112 and/or OBD device 108, including LF RF detection data received from a plurality of vehicles 102, in database 118.

OBD device 108 can be equipped with a variety of sensor types such as, but not limited to, temperature sensors, accelerometers, gyroscopes, voltage sensors, etc. OBD device 108 can be equipped with a location positioning system, such as a global satellite positioning system (GPS) or other location determining system, as well as one or more wireless interfaces for interfacing with other vehicles and/or systems. For example, OBD device 108 can include one or more wireless interfaces for providing a location in real-time while detecting LE RF beacons and transmitting detection data over a satellite network, cellular network, LoRa network, etc. to the cloud or backend system.

Depending on a preferred implementation, mobile LE RF reader device 112 can include an LE RF transmitter and/or LE RF receiver and antenna components in various form factors. For example, an LE RF radio can be included as a single system on a chip with an integrated microprocessor or microcontroller and memory, or as a standalone integrated circuit (IC) with an external microprocessor. Mobile LE RF reader device 112 can be configured with different antenna types, such as a surface mount ceramic chip antenna, a printed circuit board trace antenna, an antenna formed of or as part of an external housing, etc. having an omnidirectional 2.4 gigahertz antenna pattern. In some implementations, Mobile LE RF reader device 112 can be configured to continuously store detection samples in local memory, and upon reaching a time or event to send detection data, microprocessor can instruct wireless backhaul interface 110 to transmit detection data associated with detection of LE RF beacons to network server 116.

In some cases, to reduce an amount of battery life used to write to nonvolatile memory (e.g., flash or electrically erasable programmable read-only memory (EEPROM), the detection data can be written to static random-access memory (SRAM) as long as power is available so that data is not lost. A frequency of writing detection data to memory and/or transmission to network server 116 can be controlled to limit impact on battery life. In some cases, a filter can be included with LE RF reader device 112 to filter out and/or discard detection data (e.g., when an RSSI level falls below a given threshold, when RSSI data is not collected over a sufficient time period (e.g., vehicle speed has limited an amount of detections), for unknown or unregistered MAC addresses, etc.) to assist in conserving battery life, processing resources, and memory by limiting what data is collected and ultimately sent to network server 116.

FIG. 2 is a block diagram of an example wireless backhaul implementation that includes two vehicles 102a and 102b. As described above, OBD device 108 and/or standalone LE RF reader devices 112 can be configured to include one or multiple wireless backhaul interface types and associated hardware. For the example of FIG. 2, a first type of wireless backhaul interface 110 can be used to provide sensor data, including LE RF detection data, associated with vehicle 102a to network server 116. For this example, wireless backhaul interface 110 of vehicle 102a is a cellular network interface 202 (e.g., cellular LTE category) for communicating over a cellular network 204.

A second type of wireless backhaul interface 110 can be used to provide sensor data, including LE RF detection data, associated with vehicle 102b to network server 116. For this example, wireless backhaul interface 110 of vehicle 102b is a low-power, long range (LoRa) network interface 206 (e.g., 900-megahertz, low bandwidth, long range) for communicating over a LoRa wide area network (WAN) 208. Each network type will include the various hardware and infrastructure (e.g., fiber, coaxial, gateways, etc.) required to communicate with network server 116 according to the particular communication protocol.

Cellular network interface 202, LoRa network interface 206, and LE RF reader device 112 are shown outside of vehicles 102a, 102b for illustration purposes but are positioned in the interior of each vehicle in practice. In some implementations, cellular network interface 202 and LoRa network interface 206 can be included with OBD device 108 and/or LE RF reader device 112 and a hardware or software switch can be included to switch from one interface to another. For example, LoRa network interface 206 can be switched to if cellular network 204 goes down or vice versa. While this example includes two vehicles 102a and 102b, tens, hundreds, or even thousands of vehicles 102 can be configured to provide sensor data, including LE RF detection data, to one or more network servers 116 or other components.

As described below, database 118 can be configured to store detection data including, but not limited to: a location or location type associated with detected LE RF beacons, a detection time associated with detected LE RF beacons, a customer identifier and/or customer type, a vehicle identifier and/or vehicle type, a network identifier and/or network type, a user identifier and/or user type, an OBD device identifier and/or OBD device type, an LE RF reader device identifier and/or LE RF reader device type, a MAC address associated with a badge or tag, etc. For example, as vehicles 102a and 102b move from location to location, each LE RF reader device 112 can be configured to detect LE RF beacons from registered badges or tags worn by employees or other users that come in detection range of each LE RF reader device 112. The detection data can be transmitted via a wireless backhaul interface to database 118.

Accordingly, as a vehicle 102a moves from location to location, LE RF reader device 112 detects and/or stores signal data (e.g., received signal strength indicator (RSSI)) and/or identification information (e.g., media access control (MAC) addresses) associated with registered LE RF emitting badges 210 or tags. The RSSI and identification information can be used to generate end-user data, such as visualizations and statistics for example, related to which users interacted with which vehicles at certain times and/or locations. For example, based on detection data stored in database 118, a determination can be made that a certain individual (e.g., based on a badge ID) entered vehicle 102a, walked by vehicle 102b, or drove a vehicle 102b (e.g., based on vehicle ID, LE RF reader device, OBD device ID) from a first location to a second location (e.g., based on GPS data).

As described above, while in motion or at rest, each LE RF reader device 112 can be configured to detect LE RF beacons, which also can be associated with fixed or moving objects or assets. Backend logic can be used to discriminate received LR RF signals, based on signal strength data and location data, when multiple LE RF reader devices 112 are in detection range of multiple emitting LE RF transmitters. For example, an LE RF badge of a user may be detected by multiple moving LE RF reader devices 112 (e.g., a LE RF reader array) of multiple vehicles 102, and onboard logic and/or backend logic can be used to identify how the user interacted with or moved in relation to each vehicle 102 of the array according to the badge ID and RSSI values detected.

According to an example, LE RF reader device 112 and/or wireless backhaul interface 110 can be controlled via a backend controller (e.g., control logic included with network server 116 or other dedicated server) to selectively be added or removed from a reader array of vehicles in order to provide different zones of reader and/or detection coverage. According to an aspect, wireless backhaul interface 110 can be configured to provide feedback to enable backend logic to coordinate which LE RF reader devices 112 are to be turned on or oft have longer or shorter duration detection windows, etc. according to a particular implementation. For example, a controller can be configured to send a signal to LE RF reader device 112 of vehicle 102a to power off or remain in a reduced power mode for a certain amount of time when an LE RF beacon has not been detected by LE RF reader device 112 for some period of time.

According to an aspect, each LE RF reader device 112 can be configured also to transmit messages to other registered LE RF reader devices 112 as part of automatically configuring the detection sources of a coverage zone(s) or reader array. One or more vehicles 102 of a coverage zone can provide feedback to the controller to coordinate which LE RF reader devices 112 to turn off, change power modes, reduce detection intervals, reduce how often a detection window opens, reduce a detection frequency, etc. to conserve battery life. Amount of available battery charge, location, engine state, static or moving, detection history, number of detections within a given time period, predicted future detections, etc. can be used as measures to control and/or coordinate operation and functionality of registered LE RF reader devices 112 as part of providing power management functionality.

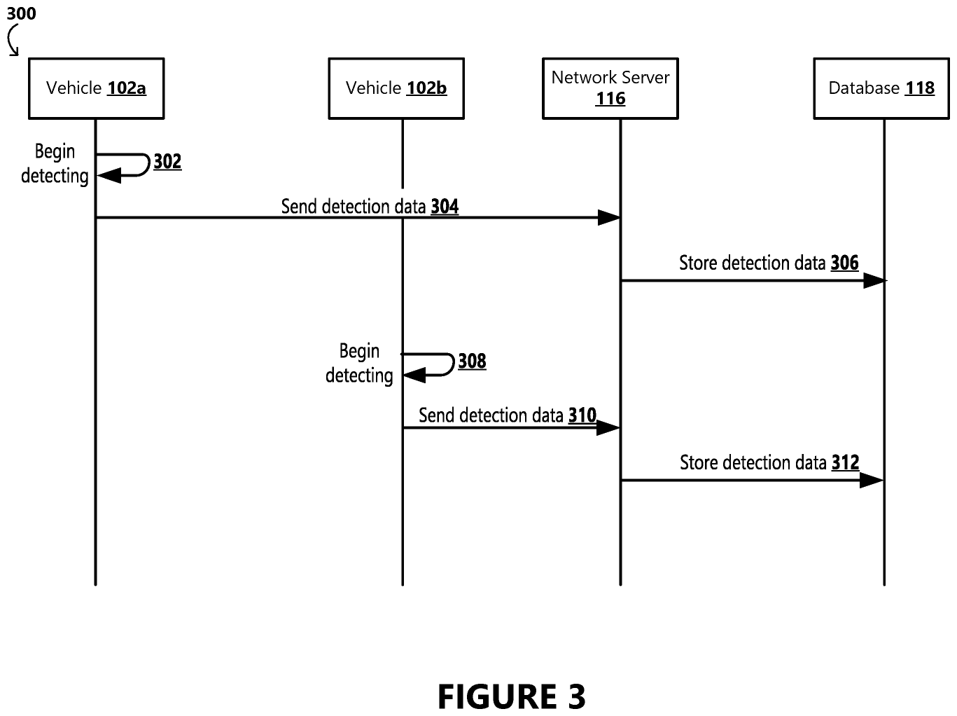

FIG. 3 is a communication diagram of an exemplary asset tracking process 300 using LE RF signals. For this example, vehicle 102a and vehicle 102b each include an OBD device 108 that includes an LE RF reader device 112 and at least one wireless backhaul interface 110 (e.g., cellular network interface 202 and/or LoRa network interface 204). While two vehicles are used to illustrate asset tracking process 300, any number of vehicles can be used with asset tracking process 300. Moreover, each LE RF reader device 112 can be configured to detect LE RF beacons from a plurality of different sources and at different times and locations according to different types of trigger events.

At 302, LE RF reader device 112 of vehicle 102a is triggered to begin detecting LE RF beacons from its proximal environment at a current location as it sits idle or moves from the current location. For this example, a trigger event (e.g., bootup, connected to external voltage, battery voltage change, ignition event, engine started, vehicle movement detected by onboard accelerometer, etc.) has caused LE RF reader device 112 of vehicle 102a to begin detecting LE RF beacons for a particular time period (e.g., detection time window) and interval with or without a stop detection time, or constantly until a stop detection event (e.g., disconnected from external voltage, battery voltage change, engine stopped or idle, no vehicle movement detected by onboard accelerometer, time to stop detection, end of detection time window, etc.).

A detection time window can be configured according to a particular implementation taking into account an amount of memory required to store LE RF detection data as well as an amount of power consumed during the detection window. For example, during the detection window having a fixed time duration, LE RF reader device 112 of vehicle 102a may have detected LE RF beacons transmitted by a first registered badge (e.g., first MAC address) of a first employee or user and a second registered badge (e.g., second MAC address) of a second employee at a first location, and may have detected LE RF beacons transmitted by a third registered badge (e.g., third MAC address) of a third employee after moving to a second location. In this way, interactions with vehicle 102a can be tracked.

At 304, cellular network interface 202 of vehicle 102a is used to send all or a portion of the LE RF detection data to network server 116. For example, cellular network interface 202 of vehicle 102a can be configured to send each MAC address with SNR or RSSI value(s) and time and location of detection events. According to an aspect, a detection threshold (e.g., RSSI threshold, signal-to-noise (SNR) threshold, etc.) can be used to filter out LE RF detection data that does not meet the detection threshold. For example, the detection threshold can be used by LE RF reader device 112 to reject beacons that do not meet the detection threshold and/or reduce an amount of LE RF detection data sent to network server 116 via cellular network interface 202. At 306, network server 116 stores received LE RF detection data of vehicle 102a in database 118. For example, LE RF detection data can be stored in database 118 according to a vehicle ID or other identifier. According to one aspect, the LE RF detection data detected by vehicle 102a can be deleted from onboard memory once received by network server 116 and/or stored in database 118.

At 308, LE RF reader device 112 of vehicle 102b is triggered to begin detecting LE RF beacons from its proximal environment at a current location as it sits idle or moves from the current location. For this example, a trigger event (e.g., battery voltage change, engine started, vehicle movement detected by onboard accelerometer, etc.) has caused LE RF reader device 112 of vehicle 102b to begin detecting LE RF beacons for a particular time period (e.g., detection window) or constantly until a stop detection event (e.g., battery voltage change, engine stopped or idle, no vehicle movement detected by onboard accelerometer, etc.). For example, during the detection window having a fixed time duration, LE RF reader device 112 of vehicle 102b may have detected LE RF beacons transmitted by a fourth registered badge (e.g., fourth MAC address) of a fourth employee or user at a third location, and may have detected LE RF beacons transmitted by the first registered badge (e.g., first MAC address) of the first employee after moving to the first location. In this way, interactions with vehicle 102b can be tracked.

At 310, LoRa network interface 202 of vehicle 102b is used to send all or a portion of the LE RF detection data to network server 116. For example, LoRa network interface 202 of vehicle 102b can be configured to send each MAC address with SNR or RSSI value(s) and time and location of detection events. According to an aspect, a detection threshold (e.g., RSSI threshold, signal-to-noise (SNR) threshold, etc.) is used to filter out LE RF detection data that does not meet the detection threshold. For example, the detection threshold can be used by LE RF reader device 112 to reject beacons that do not meet the detection threshold and/or reduce an amount of LE RF detection data sent to network server 116 via LoRa network interface 202. At 312, network server 116 stores received LE RF detection data in database 118. For example, LE RF detection data can be stored in database 118 according to a vehicle ID or other identifier. According to one aspect, the LE RF detection data detected by vehicle 102b can be deleted from onboard memory once received by network server 116 and/or stored in database 118.

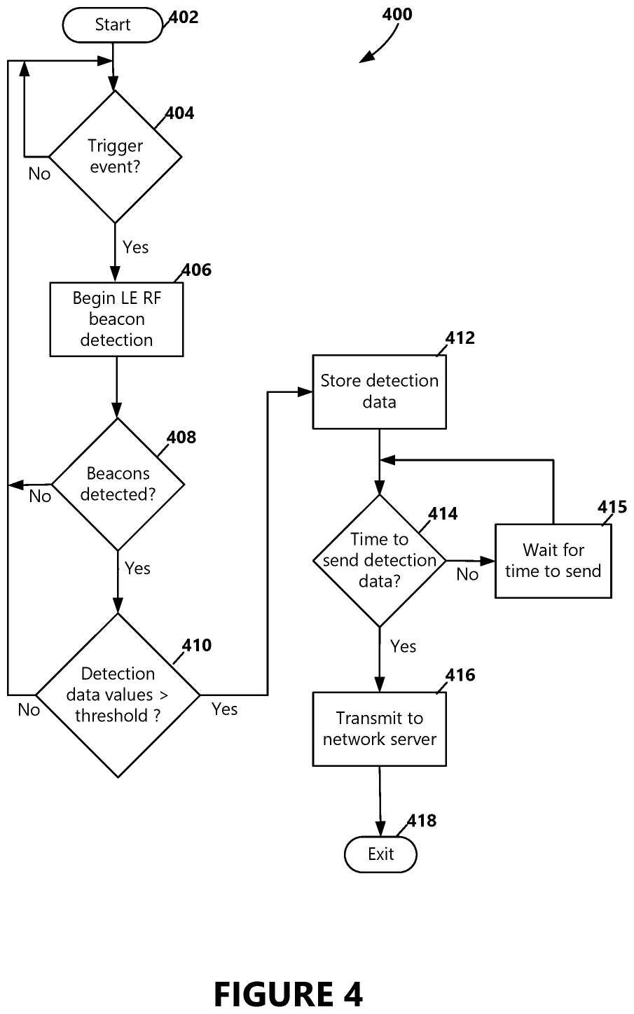

FIG. 4 is a flow diagram of an exemplary method 400 of using LE RF reader technology to dynamically track assets. Method 400 can be configured to use a plurality of distributed LE RF reader devices 112 mounted on vehicles 102 or other movable or moving assets to detect LE RF beacons from LE RF transmitters attached to or held by static or moving assets. At 402, method 400 begins and proceeds to 404. If a trigger event occurs at 404, method 400 proceeds to 406 and begins detecting LE RF beacons using LE RF reader device 112. For example, opening or remotely unlocking a vehicle door can be used as a trigger event to wake up LE RF reader device 112 to detect LE RF beacons for a defined time duration or detection window. If a trigger event does not occur, method 400 returns to 402 and waits for a trigger event to occur.

If LE RF beacons were not detected by LE RF reader device 112 at 408, method 400 returns to 402 and waits for a trigger event to occur. If LE RF beacons are detected by LE RF reader device 112 at 408, method 400 proceeds to 410. According to an aspect, at 410 LE RF reader device 112 uses a filter to filter out unwanted or unusable detection data based on a detection threshold or other measure as part of limiting impact on power, processing, and/or memory resources. At 410, if detection data values associated with the LE RF beacons are greater than or equal to the detection threshold (e.g., RSSI threshold or SNR threshold), method 400 proceeds to 412.

At 412 method 400 stores the detection data in local memory and/or remotely. For example, method at 412 can store vehicle IDs, MAC addresses associated with devices (e.g., badges, tags, etc.) that transmitted LE RF beacons, device IDs (e.g., badge IDs, tag IDs, etc.), received signal levels (e.g., RSSI values, SNR values, etc.), detection time(s) and location(s), etc. According to an aspect, an RSSI value can be determined by processing the average RSSI value over a 5 to 30 second scan window, and selecting the highest or peak value as the representative value for storing locally and/or sending to network server 116. As an example, for vehicles that are not moving, OBD device 108 can be configured to use wireless backhaul interface 110 to transmit detection data to network server 116 every 8 hours, whereas the detection data can be transmitted every 30-90 seconds for vehicles in motion.

In some cases, the detection data may be sent immediately to network server 116. If the detection data values associated with the LE RF beacons are not greater than or equal to the detection threshold at 410, method 400 returns to 402 and waits for a trigger event to occur. In some aspects, method 400 can be executed as a loop to continuously monitor for trigger events as long as a battery voltage is above a certain voltage threshold. If it is not time to send detection data to network server 116 at 414, method 400 proceeds to 415 and waits for a time or event to send the detection data.

If it is time to send detection data to network server 116 at 414, method 400 proceeds to 416 and uses wireless backhaul interface 110 to transmit all or a portion of the detection data to network server 116 before method 400 exits at 418. For example, time to send detection data can be configurable and may correspond to a defined time, event, and/or location. The time to send data can also be tied to an amount of onboard memory remaining, an amount of time elapsed since a previous a detection window, a network signal strength, etc. Depending on a particular implementation, method 400 can use wireless backhaul interface 110 to transmit detection data to network server 116 for each individual vehicle ID or MAC address, or can transmit the detection data received from a variety of assets in batches.

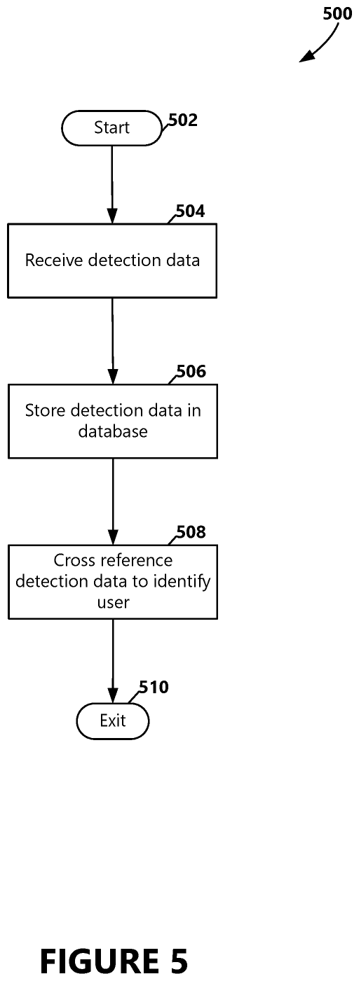

FIG. 5 is a flow diagram of an exemplary method 500 of receiving detection data over a network from a plurality of dynamic LE RF reader devices 112 as part of detecting and/or tracking assets. For example, method 500 can be executed to manage large amounts of detection data provided by an array of LE RF reader devices 112 associated with vehicles of a vehicle fleet after detecting registered LE RF emitting badges or tags worn by employees or other users. Method 500 starts at 502 and proceeds to 504.

At 504, method 500 receives detection data at network server 116 from one or more OBD devices 108 and/or LE RF reader devices 112. For example, method 500 at 504 can be configured to receive detection data from multiple vehicles located in different locations at the same time or at different times, wherein the detection data includes one or more of: a vehicle ID or LE RF reader device ID or OBD device ID, a MAC address of a detected badge or tag, an RSSI value associated with each detected badge or tag, a time of detection, a detection location, etc. for each vehicle or other object that includes an LE RF reader devices 112.

At 506, method 500 stores the detection data in database 118. For example, at 506 method operates to store vehicle IDs, MAC addresses associated with devices (e.g., badges, tags, etc.) that transmitted LE RF beacons, device IDs (e.g., badge IDs, tag IDs, etc.), received signal levels (e.g., RSSI values, SNR values, etc.), detection time(s) and location(s), etc. At 508, method 500 operates to cross reference the detection data and a badge ID or tag ID with registration data (e.g., MAC addresses) stored in database 118 to identify an employee or user that has been registered with the associated badge or tag before method 500 exits at 510.

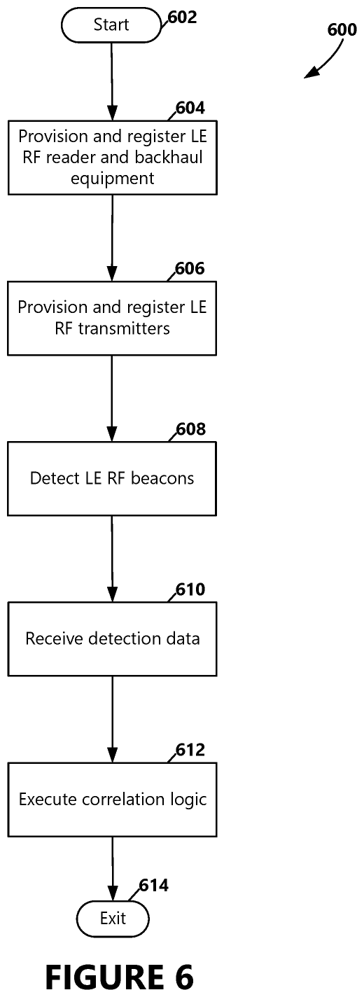

FIG. 6 is a flow diagram of an exemplary method 600 of provisioning LE RF reader devices 112 and LE RF badges and/or LE RF tags for a customer at one or more customer sites. Method 600 starts at 602 then proceeds to 604 where OBD devices 108 that each include at least one wireless backhaul interface 110 (e.g., LoRa or cellular) and an LE RF reader device 112 are provisioned and registered for the customer network to operate at the customer site. In some cases, a standalone ruggedized device that includes a power source, a location system, at least one wireless backhaul interface 110, and/or an LE RF reader device 112 can be coupled with an OBD device 118 or other component to detect LE RF beacons at the customer site.

At 606, method 600 provisions and registers LE RF beacon devices (e.g., badges or lanyards) with LE RF transmitters to employees of the customer, wherein a registration process correlates each employee ID with a MAC address of a corresponding LE RF beacon device. IDs of LE RF reader devices 112 and/or OBD devices 118 along with employee IDs and MAC addresses are stored in database 118. At 608, method 600 uses LE RF reader devices 112 to detect LE RF beacons as employees move within detection distance (e.g., −30-100 feet) of an LE RF reader device as part of trip level tracking, overall asset management, etc.

As described above, LE RF reader devices 112 are dynamic in that they can move with vehicles or other objects that they are installed in or coupled to. At 610, method 600 receives detection data at network server 116 from one or more OBD devices 108 and/or LE RF reader devices 112 along with signal strength values (e.g., RSSI values, SNR values, etc.), location information (e.g., GPS position messages), and/or LE RF beacon device IDs (e.g., MAC addresses). At 612, method 600 executes correlation logic to query database 118 to link employees with LF reader locations for reporting and quantifying reader-user interactions and method 600 exits at 614.

As an implementation example, a vehicle lot owner/manager may have limited insight regarding how employees are interacting with vehicles on of each lot. Once LF RF beacon devices (e.g., badge or lanyard with BLUETOOTH interfaces) are assigned to employees and registered with database 118, the lot owner is able to track employees as they interact with vehicles equipped with LE RF reader devices 112. As LF RF beacon devices transmit LE RF signals at 0.9-1 second intervals; surrounding, and sometimes moving, LE RF reader devices 112 can scan for, receive, and report detection data associated with LE RF beacon detections. Network server 116 can include backend logic that links each beacon identifier (e.g., MAC address) to an employee and reports beacon identifiers with signal strength values in relation to registered LE RF reader devices 112 or OBD devices 108 for static and dynamic asset and employee tracking. Using the detection data, a customer gains visibility into personnel, vehicle locations, and how they interact with one another. A customer is then able to determine who is engaged with which asset(s) to gain insight about efficiencies of operations, resource allocation, and/or generate performance reporting.

In contrast to the dynamic nature of the disclosed aspects, current tracking devices require a stationary component. As described herein, disclosed aspects enable tracking of assets, such as vehicles, and people as they both move in relation to one another to provide a live and dynamic view of how assets interact. The disclosed aspects can be applied to a variety of different use cases wherein multiple LE RF reader devices 112 move from location to location as one or multiple users interact with an object or asset associated with each LE RF reader device 112. Aspects described herein, can also use multiple LE RF reader devices 112 to detect LE RF beacons from stationary objects.

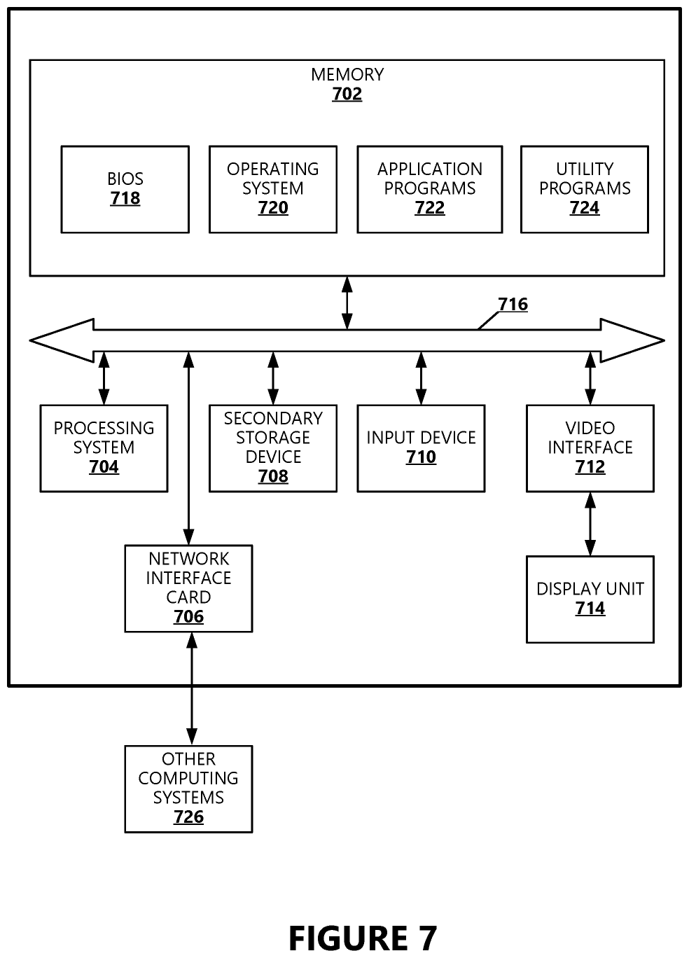

FIG. 7 is a block diagram illustrating example physical components of a computing device 700 or system with which embodiments may be practiced as part of providing a platform for tracking assets based on reception of LE RF signals. For example, computing device 700 can be representative of network server 116. It should be appreciated that in other embodiments, different hardware components other than those illustrated in the example of FIG. 7 may be used. Computing devices may be implemented in different ways in different embodiments. For instance, in the example of FIG. 7, the computing device 700 includes a processing system 704, memory 702, a network interface card 706 (wired and/or wireless, cellular type, 802.11 type, etc.), a secondary storage device 708, an input device 710, a video interface 712, a display unit 714, and a communications medium 716. In other embodiments, the computing device 700 may be implemented using more or fewer hardware components (e.g., a video interface, a display unit, or an input device) or in combination with other types of computer systems and applications 726.

The memory 702 includes one or more computer-readable storage media capable of storing data and/or computer-executable instructions. Memory 702 may store the computer-executable instructions that, when executed by a processor of the processing system 704, store asset tracking information in database 118. In various embodiments, the memory 702 is implemented in various ways. For example, the memory 702 can be implemented as various types of computer-readable storage media. Example types of computer-readable storage media include, but are not limited to, solid state memory, flash memory, dynamic random access memory (DRAM), double data rate synchronous dynamic random access memory (DDR SDRAM), DDR2 SDRAM, DDR3 SDRAM, read-only memory (ROM), reduced latency DRAM, electrically-erasable programmable ROM (EEPROM), and other types of devices and/or articles of manufacture that store data.

The term computer-readable storage medium may also refer to devices or articles of manufacture that store data and/or computer-executable instructions readable by a computing device. The term computer-readable storage media encompasses volatile and nonvolatile, removable and non-removable media implemented in various methods or technologies for storage and retrieval of information. Such information can include data structures, applications, computer-executable instructions, or other data.

The processing system 704 includes one or more processing units, which may include tangible integrated circuits that selectively execute computer-executable instructions. In various embodiments, the processing units in the processing system 704 are implemented in various ways. For example, the processing units in the processing system 704 can be implemented as one or more processing cores. In this example, the processing system 704 can comprise one or more microprocessors. In another example, the processing system 704 can comprise one or more separate microprocessors. In yet another example embodiment, the processing system 704 can comprise Application-Specific Integrated Circuits (ASICs) that provide specific functionality. In yet another example, the processing system 704 provides specific functionality by using an ASIC and by executing computer-executable instructions.

The computing device 700 may be enabled to send data to and receive data from a communication network via a network interface card 706. In different embodiments, the network interface card 706 is implemented in different ways, such as an Ethernet interface, a token-ring network interface, a fiber optic network interface, a wireless network interface (e.g., cellular, WIFI, Wi-Max, etc.), or another type of network interface. The network interface may allow the device to communicate with other devices, such as over a wireless network in a distributed computing environment, a satellite link, a cellular link, and comparable mechanisms. Other devices may include computer device(s) that execute communication applications, storage servers, and comparable devices.

The secondary storage device 708 includes one or more computer-readable storage media, and may store data and computer-executable instructions not directly accessible by the processing system 704. That is, the processing system 704 performs an I/O operation to retrieve data and/or computer-executable instructions from the secondary storage device 708. In various embodiments, the secondary storage device 708 can be implemented as various types of computer-readable storage media, such as by one or more magnetic disks, magnetic tape drives, CD-ROM discs, DVD-ROM discs, BLU-RAY discs, solid state memory devices, and/or other types of computer-readable storage media.

The input device 710 enables the computing device 700 to receive input from a user. Example types of input devices include, but are not limited to, keyboards, mice, trackballs, stylus input devices, key pads, microphones, joysticks, touch-sensitive display screens, and other types of devices that provide user input to the computing device 700.

The video interface 712 outputs video information to the display unit 714. In different embodiments, the video interface 712 is implemented in different ways. For example, the video interface 712 is a video expansion card. In another example, the video interface 712 is integrated into a motherboard of the computing device 700. In various embodiments, the display unit 714 can be an LCD display panel, a touch-sensitive display panel, an LED screen, a projector, a cathode-ray tube display, or another type of display unit. In various embodiments, the video interface 712 communicates with the display unit 714 in various ways. For example, the video interface 712 can communicate with the display unit 714 via a Universal Serial Bus (USB) connector, a VGA connector, a digital visual interface (DVI) connector, an S-Video connector, a High-Definition Multimedia Interface (HDMI) interface, a DisplayPort connector, or another type of connection.

The communications medium 716 facilitates communication among the hardware components of the computing device 700. In different embodiments, the communications medium 716 facilitates communication among different components of the computing device 700. For instance, in the example of FIG. 7, the communications medium 716 facilitates communication among the memory 702, the processing system 704, the network interface card 706, the secondary storage device 708, the input device 710, and the video interface 712. In different embodiments, the communications medium 716 is implemented in different ways, such as a PCI bus, a PCI Express bus, an accelerated graphics port (AGP) bus, an InfiniBand® interconnect, a serial Advanced Technology Attachment (ATA) interconnect, a parallel ATA interconnect, a Fiber Channel interconnect, a USB bus, a Small Computing system Interface (SCSI) interface, or another type of communications medium.

The memory 702 stores various types of data and/or software instructions. For instance, in the example of FIG. 7, the memory 702 stores a Basic Input/Output System (BIOS) 718, and an operating system 720. The BIOS 718 includes a set of software instructions that, when executed by the processing system 704, cause the computing device 700 to boot up. The operating system 720 includes a set of software instructions that, when executed by the processing system 704, cause the computing device 700 to provide an operating system that coordinates the activities and sharing of resources of the computing device 700. The memory 702 also stores one or more application programs 722 or program code that, when executed by the processing system 704, cause the computing device 700 to provide applications to users including tracking applications that enable customers to display asset locations and/or employees who were detected at or near an asset location. The memory 702 also stores one or more utility programs 724 that, when executed by the processing system 704, cause the computing device 700 to provide utilities to other software programs.

Embodiments may be used in combination with any number of computer systems, such as in server environments, desktop environments, laptop or notebook computer systems, multiprocessor systems, micro-processor based or programmable consumer electronics, networked PCs, mini computers, main frame computers and the like. Embodiments may be utilized in various distributed computing environments where tasks are performed by remote processing devices that are linked through a communications network in a distributed computing environment, and where program code may be located in local and/or remote memory storage (e.g., memory and/or disk(s)).

All system components described herein may be communicatively coupled via any method of network connection known in the art or developed in the future including, but not limited to wired, wireless, modem, dial-up, satellite, cable modem, Digital Subscriber Line (DSL), Asymmetric Digital Subscribers Line (ASDL), Virtual Private Network (VPN), Integrated Services Digital Network (ISDN), X.25, Ethernet, token ring, Fiber Distributed Data Interface (FDDI), IP over Asynchronous Transfer Mode (ATM), Infrared Data Association (IrDA), WAN technologies (T1, Frame Relay), Point-to-Point Protocol over Ethernet (PPoE), etc. including any combination thereof.

Aspects, for example, are described above with reference to block diagrams and/or operational illustrations of methods, systems, and computer program products according to embodiments. The functions/acts noted in the blocks can occur out of the order as shown in any flowchart or described herein. For example, two processes shown or described in succession can in fact be executed substantially concurrently or the blocks can sometimes be executed in the reverse order, depending upon the functionality/acts involved.

While certain embodiments have been described, other embodiments may exist. Furthermore, although embodiments have been described as being associated with data stored in memory and other storage mediums, data may also be stored on or read from other types of computer-readable storage media. Further, the disclosed processes may be modified in any manner, including by reordering and/or inserting or deleting a step or process, without departing from the embodiments.

The foregoing description has been presented for the purposes of illustration and description. It is not intended to be exhaustive or to limit the embodiments to the precise forms disclosed. Many modifications and variations are possible in light of the above teaching. It is intended that the scope of the invention be limited not with this detailed description, but rather by the claims appended hereto.

What is claimed is:

1. A system comprising:
at least one movable object that includes:
a global positioning system (GPS) configured to track a location of the at least one movable object;
a radio frequency (RF) reader interface configured to receive low-energy (LE) RF beacons from LE RF transmitters; and
a wireless backhaul interface to provide detection data associated with received LE RF beacons;
a plurality of LE RF transmitters coupled to a plurality of assets, each LE RF transmitter having at least one battery and configured to transmit RF beacons;
a network server to receive the detection data from the wireless backhaul interface of the at least one movable object; and
a database to store the detection data received by the network server.

2. The system of claim 1, wherein the wireless backhaul interface comprises a cellular network interface.

3. The system of claim 1, wherein the wireless backhaul interface comprises a low-power, long-range (LoRa) network interface.

4. The system of claim 1, wherein the wireless backhaul interface comprises a cellular network interface and an LoRa network interface.

5. The system of claim 1, wherein the at least one movable object comprises a vehicle equipped with an onboard diagnostics (OBD) device.

6. The system of claim 5, wherein the RF reader interface and wireless backhaul interface are included with the OBD device.

7. The system of claim 5, wherein the RF reader interface and wireless backhaul interface are included as an integrated device on a silicon chip and coupled to the OBD device, the system further comprising a battery for powering the integrated device.

8. The system of claim 1, wherein the RF reader interface is configured to receive LE RF beacons from one or more of the LE RF transmitters, each LE RF transmitter having a power consumption of less than about 15 milliamperes (mA) and a frequency band of about 2.4 gigahertz (GHZ).

9. The system of claim 1, wherein the RF reader interface includes an antenna having an omni-directional antenna pattern.

10. The system of claim 1, wherein the RF reader interface is provided power from a battery of the at least one movable object.

11. The system of claim 1, wherein the RF reader interface is powered on to receive LE RF beacons based on a trigger event that includes at least one of: connection to a power source, motion of the at least one movable object, a location of the at least one movable object, a voltage level of a battery of the at least one movable object, disconnection from the power source, continuous motion, end of motion or motion stop, and a network-based trigger, wherein the network server instructs the RF reader interface to scan.

12. The system of claim 1, wherein the RF reader interface includes a transmitter and a receiver.

13. The system of claim 1, further comprising a programmable filter configured to filter out LE RF beacons having a particular MAC address or signal strength value, wherein the system provides filtered detection data to the network server.

14. An apparatus configured to be coupled to an onboard diagnostics (OBD) device, the apparatus comprising:
a battery;
a global positioning system (GPS) configured to track a location of the apparatus;
a radio frequency (RF) reader interface configured to receive low-energy (LE) RF beacons from LE RF transmitters;
a filter to filter the detection data;
a wireless backhaul interface to provide filtered detection data associated with received LE RF beacons to a network server; and
memory to store the filtered detection data.

15. The apparatus of claim 14, wherein the RF reader interface is configured to detect LE RF beacons based on a trigger event or during a scheduled window or time event according to wake-up programming to perform certain actions at certain times.

16. The apparatus of claim 15, wherein the trigger event includes a timing event, a voltage level change of the battery, or movement of the apparatus.

17. The apparatus of claim 15, wherein the wireless backhaul interface is configured to provide filtered detection data associated with received LE RF beacons to a network server according to a defined time, event, or location.

18. A method comprising:
associating a plurality of radio frequency (RF) reader interfaces with a plurality of moveable objects, each RF reader interface configured to receive low-energy (LE) RF beacons from LE RF transmitters;
associating a plurality of LE RF transmitters with a plurality of moveable assets;
detecting, via at least one of the plurality of RF reader interfaces, one or more LE RF beacons transmitted by at least one of the plurality of LE RF transmitters;
determining, via the at least one of the plurality of RF reader interfaces, if a signal strength level associated with a received LE RF beacon satisfies a signal strength condition; and
if the signal strength level associated with the received LE RF beacon satisfies the signal strength condition, transmitting, via a wireless backhaul interface associated with the at least one of the plurality of RF reader interfaces, detection data to a network server.

19. The method of claim 18, wherein the wireless backhaul interface is a cellular network interface or a low-power, long-range (LoRa) network interface.

20. The method of claim 18, further comprising an onboard diagnostics (OBD) device coupled to at least one RF reader interface of the plurality of RF reader interfaces and the wireless backhaul interface.
